(19) United States
(12) Patent Application Publication
(10) Pub. No.: US 2004/0196778 A1
(43) Pub. Date: Oct. 7, 2004

(54) Digital optical data carrier in disc format

(76) Inventor: Dieter Dierks, Pulheim (DE)

Correspondence Address: John Lezdey & Associates, Suite 302, 4625 East Bay Drive, Clearwater, FL, 33764, US

(21) Appl. No.: 10/827,012

(22) Filed: Apr. 19, 2004

Related U.S. Application Data
(63) Continuation-in-part of application No. 09/455,980, filed on Nov. 30, 1999.

(30) Foreign Application Priority Data
Dec. 1, 1998 (DE) 198 55406.0

(51) Int. Cl. G11B 7/24

(52) U.S. Cl. 369/286; 369/283; 369/94

(57) ABSTRACT

A digital optical data carrier in disc format having two separate discs adhered together. One of the discs has data storage in CD-format. The other disc has data storage in DVD-format. At least one surface has an optically readable information printed with a laser absorbing colorant.

### FIELD OF THE INVENTION

The invention relates to a digital optically readable data carrier in disc format with two disc surfaces.

### BACKGROUND OF THE INVENTION

Digital storing, optically readable data carriers in disc format are known under the name CD which are flat, perforated plastic discs. They have two disc surfaces, the one being meant for data recording, the other for standard readable information. Such record-like CDs have become generally accepted, they largely superseded the earlier used records, particularly the black vinyl discs.

U.S. Pat. No. 6,205,112 to Weidner discloses a digital optical data carrier having a DVD-format on one side readable by a DVD player and a CD-format on the other side readable by a CD player that is a one piece substrate. Weider does not teach the use of dyes transparent to laser but readable by humans as markings on the carrier surfaces.

Another type of digital optically readable data carrier in disc format is the so-called DVD (digital versatile disc) that has the same size as the CD. Their storage capacity is bigger. The technical basic concept is comparable to the one of the CDs. Here too, a reflecting layer is scanned by laser beams that are looking for impressions, so-called pits. As opposed to the CD, smaller pits are used for the DVD, the radial spacing between the arcs with pits is smaller, the spacing between the different pits on one arc is smaller too. A considerably higher capacity is thus achieved. The DVD in its smallest version already has 4, 7 GBytes, which corresponds to approximately the sevenfold capacity of a standard CD. The current DVD specification allows capacities of up to 17 GBytes, which makes approximately nine hours film or 26 CDs.

CD-drives may play CDs. DVD-drives may play CDs as well as DVDs, in other words, these drives are downward compatible. They usually bear with all CD-versions, inclusive re-recordable CDs, as for example CD-Rs and CD-RWs. CD-drives cannot play DVDs.

To play videos from DVDs usually only works with the help of a good compression method. The so-called MPEG-method has gained acceptance as a standard for the video compression with DVD-videos. It is also possible to store audio-signals on DVDs, the currently used format being AC-3. DVDs may be used just as CDs for the reproduction of data. They may be used for example for the permanent storage of computer programs.

In spite of their advantages, DVDs have not gained big acceptance in standard households and with normal users. This is mainly due to the fact that the prices for the players are still quite high. Moreover, not so long ago, lots of users switched from the old record to CD and are now hesitating to change again. All this explains the not yet satisfactory acceptance of the storage medium DVD.

### SUMMARY OF THE INVENTION

The object of the invention is to provide a storage medium of the type mentioned above that may be used also by users and owners of the CD-players of the art but that already bears the germ of the new DVD-generation, that is to say that it may also be used with more modern DVD-players.

More particularly, there is provided a digital optical data carrier comprising two separate and attached discs. One disc is provided with a CD-format and the other disc is provided with a DVD-format. At least one disc has a surface carrying an optically readable format. The optically readable format is provided with a dye that absorbs the laser radiation of the DVD-drive which usually works with a wavelength that is considerably smaller than the lasers used with the CD-drive.

Footing on the digital optically readable storage medium in disc format as mentioned above, the solution of the invention is to provide one disc surface with data storage in CD-format and the other surface with data storage in DVD-format.

According to the invention, the data carrier is working like a CD of the art. It is recorded on one side with a storage layer carrying a record in CD-format. Up to here, there is no difference compared to the old CD. For the user who only wants to use the CD-formatted disc surface, the data disc according to the invention works like a normal CD.

Additionally in the data carrier according to the invention the other disc surface, which, in a CD of the art, is not used for data recording, is also optically recorded. It carriers a data recording in DVD-format. The data carrier according to the invention is working on this disc surface like a DVD-disc. The only difference, compared to a standard DVD-disc, is that only one of the two data loaded disc surfaces is recorded in DVD-format.

The manufacturing costs are not considerably increased by the additional storage of data on the second surface. The material costs are more or less the same as with a standard CD or DVD.

The advantage of the user is that, with a DVD-player, the data carrier according to the invention may be read on both sides. Usually the CD-coded side carries considerably less informations than the DVD-coded disc surface. Still both disc surfaces may be acquired and reproduced by a DVD-player.

The advantage for the user is that he may use his existing CD-player to play the data disc according to the invention, but that he may also play it when he buys a DVD-player.

The invention particularly relates to already recorded, read-only memories, so-called ROMs. It may also be used for recordable data carriers but its particular advantage lies in the first mentioned application. In said application, a big amount of data carriers according to the invention may be machined by using forms for making the pits that are appropriate for the two disc surfaces. The industrial production procedure is known and remains the same for the present invention.

The invention may also be understood in the way that a CD of the art is additionally provided, on its passive surface used for normal reading, with a DVD-readable, recorded surface. The invention is particularly suitable for similar records on both disc surfaces of the plastic disc. On the CD-coded side, a plurality of pieces of music by a group or a composer may for example be recorded according to the capacity of said side. On the other disc surface, the DVD-coded one, the much higher capacity is used to not only store the same audio signals but also to provide video signals, for example video signals on the group playing said pieces or on the orchestra that was video-recorded while the sound recording took place. Such a double record is particularly suited for the data carrier according to the invention. When the user is switching from the CD-drive to the DVD-drive, he gains, on top of the constant sound quality, the additional video event. An alternative is to provide more music on the DVD-side, so that the extra capacity is used to store additional pieces of music.

The CD-coded disc surface preferably carries a fraction of the information stored on the DVD-coded disc surface.

The producer of such data carriers may thus touch different users with one and the same product. The producer of an encyclopedia on digital storage media may for example produce and offer its data carriers in the version according to the invention. He thus satisfies customers having a CD-player as well as those having a DVD-player. A software producer may proceed in the same way. The format at the data carrier, which often has to be considered when buying particularly software, is no more relevant.

The structure of the data disc remains unchanged. An integral data carrier, which is standard with CDs, may be used. It is also possible, as it has mainly gained acceptance with DVDs, to glue together two or even more discs to form a data carrier having the thickness of a finished CD or of the DVD having the same thickness. The advantage of this last mentioned procedure is that the end product is not differing so much from the ideal geometry, that is, that it is essentially more plane-parallel than an integrally manufactured CD. The different manufacturing techniques have no influence on the principal of the invention, since the point of the invention is that the two disc surfaces of the data carrier are recorded in different formats, once in the CD-format, as audio CD or as data-CD, and once in the DVD-format.

In order to facilitate the use of the data disc according to the invention for somebody used to normal CDs, it is suggested that the DVD-coded surface carries optically readable information about the CD-side. In a preferred embodiment this may be achieved by coating this disc surface with a thin peelable foil that carries the information used to be given on CDs about the contents of the other side of the data carrier, that is to say the CD-coded side. Once the foil is peeled off, the DVD-side is machine readable. These data may also be printed directly onto the disc by choosing a color that is readable by human being but which is transparent for the laser used. The optical information may be located underneath the layer seized by the laser, which is underneath the pits, and may grin through said layer. It has been taken into consideration that DVDs may be recorded in different depths. For the time being, the use of several reflecting layers and the focusing of the laser onto the corresponding layer is known. Eight layers on one side have already been achieved.

In a preferred embodiment of the invention at least one disc surface is clearly marked, for example with CD or DVD. Preferably both disc surfaces are marked accordingly. Said marking may be located outside the optically readable surface but it may also be located in it. The marking CD or DVD is applied in such a size that any standard user may recognize it soon. This would prevent a CD-user from wrongly inserting the disc into his CD-drive. In that case he wouldn't hear anything or would not get the desired data. This risk is smaller with the use of DVD-drives since they may use both sides of the data disc according to the invention even if the CD-side is used less because of its information contents being considerably smaller than the DVD-coded disc surface.

A three-layer mechanical construction of the data disc according to the invention has proven to be particularly preferable. An upper, thin disc carries on its outer side the digital information in CD-format. A central disc only reproduces the informations that are readable for humans, that means that it carries on either side the corresponding contents of the disc surface. On a lower layer, that is essentially similar in construction to the upper one in disc format, the digital information is figured on the outer side in DVD-format. The three layers are glued together and are then forming a CD or DVD having the usual size.

Further advantages and characteristics of the invention will become clear in the remaining sub-claims and in the following description of embodiments that are only examples and are not limiting the scope of the invention. Said embodiments are explained in more detail with the aid of the drawing.

### BRIEF DESCRIPTION OF THE DRAWINGS

FIG. 1 a top view of a CD-disc surface of a data carrier according to the invention,

FIG. 2 a bottom view of the data carrier according to FIG. 1, this time showing the DVD-coded disc surface and

FIG. 3 an exploded view of the structure of a data disc made of three thin separate discs in an assembly drawing, whereas the three separate discs are glued together later on, constituting then a data disc of standard thickness.

### DESCRIPTION OF THE PREFERRED EMBODIMENTS

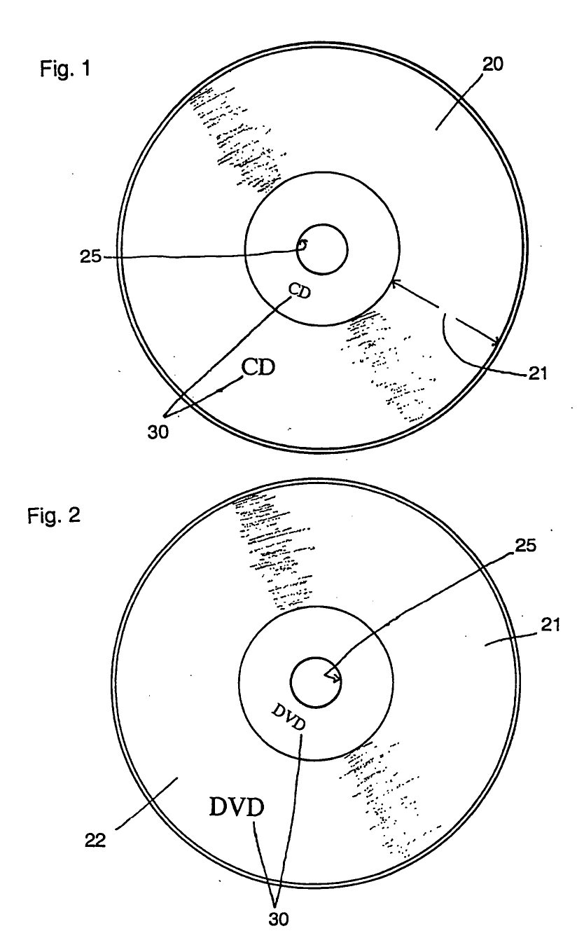

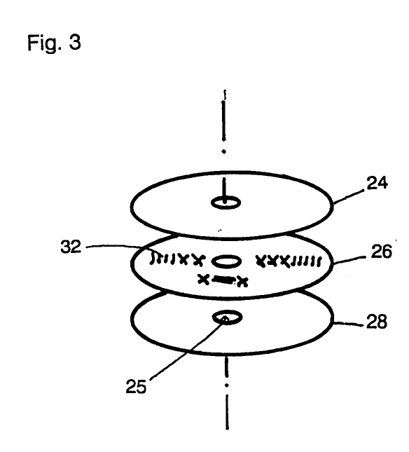

As may be seen in FIG. 1 the CD-coded disc surface 20 cannot be distinguished from a standard CD. According to the invention there is no need whatsoever to configurate said disc surface 20 in a way differing from the configuration of such a disc surface with the CDs of the art. The embodiment shown additionally carries in a transparent color or (alternatively) underneath the layer for optical figuration—see FIG. 3—a mark 30 CD. It is meant to signalize to the user that this disc surface 20 is the CD-side. 21 is the storage surface recorded with pits, 25 is a central hole.

The underside 22, that is the other disc surface 22, is DVD-coded. In order to make it as much resembling the corresponding disc surface of a standard CD as possible, optically readable information about pieces of information 23 recorded on disc surface 20, for example pieces of music, are provided on said disc surface 22. Here, the procedure according to FIG. 3 may alternatively be used. The disc surface 22 is preferably additionally marked by an imprint DVD showing the user that this is the DVD-side. Said imprint may be done in the same way as was described above for the information for the CD.

FIG. 3 shows three thin discs 24, 26, 28 that, once they are glued together, are amounting to the thickness of a standard CD or DVD. An upper disc 24 is carrying on its outer side the digital information of a CD, this surface being thus a disc surface 20.

A central disc 26 only carries optically readable information, that are printed indications 32 about the contents and so on. This disc 26 is printed on both sides. These two sides are also each provided with a mark CD or DVD so that the user may recognize the side he now wants to use. The lower disc 28 is similar in construction with the upper disc 24 but has only approx. half the thickness thereof. Its outer surface is DVD-coded. Another possibility is to print the inner sides of the discs 24, 28 and to use the disc 26 only for separation.

The laser of the DVD-drive operates at a wavelength of 0.65 micrometers. The wavelengths of lasers used for CD-drives is 0.78 micrometers. The visible spectrum of a human is between 0.4 and 0.8 micrometers.

Dyes which can be used for printing should have an absorbance in the visible spectrum, but should have as little absorption as possible in the wavelength of the lasers, i.e. for 0.65 and for 0.78 micrometer.

Possible dyes for printing directly onto the disc include merocyanines, especially a merocyanine SO117 of FEW Chemicals GmbH, ChemiePark Bitterfeld-Wolfen, Technikumstr. 1, Wolfen, Germany. The blue dye SE117 has the formula 3-ethyl-5-[2-(3-methyl-thiazolidine-2-ylidene)-ethylidene]-2-thioxo-oxazolidine-4-one, optical absorption between 300 to 500 nm and the maximum is at 452 nm. The dye has no measurable absorbance above 500 nm and especially no absorbance for the wavelengths of the lasers for DVDs, i.e. approx. 650 nm, and for the lasers for CD, i.e. approx. 780 nm. Other possible merocyanines of the same producer are S0055, which is a blue dye having an absorption between about 375 to 510 nm and the maximum at 472 nm and the formula 1.3-dimethyl-5-[2-(1-methyl-pyrolidine-2-ylidene)-ethylidene]-2-thixo-imidazolidine-4-one. S0280, which is a blue dye having an absorption between about 375 to 510 nm and the maximum at 476 nm and the formula [5-[2-(3-methyl-thiazolidine-2-ylidene)-ethylidene]-4-oxo-2-thioxo-thiazolidine-3-yl]-acetic acid. These dyes can be directly applied onto the disc surface, e.g. by preparing a solution of the dye in ethanol and using an ink jet printer as the ones used for printing on paper. The dye layer applied on the surface of the disc should be as thin as possible, a monolayer is sufficient.

According to the technical specifications, a DVD disc comprises two separate discs each having a thickness of about 0.6 mm. A CD-disc is a single piece substrate having a thickness of 1.2 mm. According to the present invention, at least two substrates of different thicknesses are adhered together to make the hybrid disc.

What is claimed:

1. A digital optical data carrier in disc format comprising at least two separate discs adhered together, one of said discs having data storage in CD-format, and the other disc having data storage in DVD-format, at least one surface of the data carrier has an optically readable information printed directly onto the disc with a dye absorbing visible light.

2. The digital optical data carrier of claim 1 wherein the data storage is in an area of the disc and readable information is outside said area of data storage.

3. The digital optical data carrier of claim 1 wherein the disc with data storage in DVD-format has a surface containing optically readable data printed directly on the disc with a dye readable by a human being and which is transparent to a laser used for reading said data storage in said DVD-format.

4. The digital optical data carrier of claim 1 wherein said dye absorbs radiation between 300 and 525 nm.

5. The digital optical data carrier of claim 4 wherein said dye is a merocyanine dye.

6. The digital optical data carrier of claim 5 wherein said merocyanine dye is selected from the group consisting of 1,3-dimethyl-5-[2-(1-methyl-pyrrolidin-2-ylidene)-ethylidene]-2-thioxo-imidazolidin-4-one, 3-ethyl-5-[2-(3-methyl-thiazolidin-2-ylidene)-ethylidene]-2-thioxo-oxazolidin-4-one, and [5-[2-(3-methyl-thiazolidin-2-ylidene)-ethylidene]-4-oxo-2-thioxo-thiazolidin-3-yl]-acetic acid.

7. The digital optical data carrier according to claim 1 wherein data is permanently stored on the disc surfaces.

8. The digital optical data carrier according to claim 1 wherein the DVD disc surface is provided with a thin, peelable film carrying normally readable information about the record on the CD-disc surface.

9. A digital optical data carrier according to claim 1 comprising three discs that are equal in area, the central disc carrying the normally readable information.

10. The digital optical data carrier of claim 1 wherein said DVD surface contains optically readable data which is not readable by a laser.

11. The digital optical data carrier of claim 1 wherein the optically readable data is on at least one foil attached to the surface with the DVD-format.

12. The digital optical data carrier of claim 1 wherein said optically readable data is below a surface readable by a laser.

13. The digital optical data carrier of claim 1 comprising three layers, the central layer carrying said optically readable data which is not readable by laser.

14. Digital optical data carrier in disc format with two separate discs (20, 22), one disc being provided with a data storage in CD-format and the other disc with a data storage in DVD-format, the separate discs (24-28) are equal in area and are glued together to form the digital optical data carrier, at least one disc has a surface (20, 22) carrying an optically readable mark, which a standard user may easily read, the mark indicating the format of the data storage of this disc, CD or DVD.

15. The digital optical data carrier according to claim 14, wherein the data storage is in an area of the disc and the mark is outside this area of the data storage.

16. The digital optical data carrier according to claim 14, wherein the disc with data storage in DVD-format has a surface containing optically readable data printed directly onto the disc by choosing a color that is readable by a human being but which is transparent for a laser used for reading said data storage in said DVD-format.
